(19) United States
(12) Patent Application Publication
(10) Pub. No.: US 2018/0341807 A1
(43) Pub. Date: Nov. 29, 2018

(54) Counterfeit article detection system

(71) Applicant: Pasquale Vincent Costa, Concord, MA (US)

(72) Inventor: Pasquale Vincent Costa, Concord, MA (US)

(73) Assignee: Valmarc Corporation

(21) Appl. No.: 14/756,845

(22) Filed: Oct. 21, 2015

(51) Int. Cl. G06K 9/00; G06K 9/32; G06K 9/20

(52) U.S. Cl. CPC G06K 9/00577; G06K 9/00671; G06K 2009/0059; G06K 9/209; G06K 9/3241

(57) ABSTRACT

This invention utilizes the random unit to unit physical differences, characteristics, inherent in any manufacturing process, especially such processes which include selected key marking or printing elements of the articles design. The key elements selected are those which facilitate detection of the unit to unit differences generated, in an uncontrolled manner, by the manufacturing process. The visual appearance to the naked eye of the unit to unit differences of such key elements usually falls below the threshold of human perception, but enables their use for ant-counterfeiting purposes.

### FIELD OF APPLICATION

This invention relates primarily to articles, and; more particularly, to a unique and relatively simple system, and tools, to facilitate distinguishing between counterfeit and non-counterfeit articles. Articles, as herein referred to includes, products, goods, manufactures, and the like and includes labeling and packaging.

### BACKGROUND DESCRIPTION

One of the obvious goals of product manufacturing methodology is achieving and maintaining an acceptable level of both product quality and manufacturing cost. The design of articles often includes some kind of counterfeit detection. Finding the right tradeoff between cost and quality can be critical to the success of the product maker's business. Permitting counterfeiters to enter the marketplace without a means to thwart them can lead to disaster.

An expectation of “quality” might include the product's ability to meet the performance levels promised by advertised product specifications. It might also include a purchaser's, consumers, etc., perception of the products color, finish, and other visually observable, aspects of physical appearance to an unaided eye. One universally accepted aspect of “quality” is the visually seen consistency of all the important aspects of a product from each individual product unit to the next; therefore, “consistency” is among several of the most important objectives of any good manufacturing process. In other words, all articles, products, etc., of the same type, (according to its SKU or stock keeping unit) are consistent to the purchaser, jobber, wholesaler, consumer, etc.

However, even in the best manufacturing process, there will be differences between one product unit and the next that cannot be seen or measured by the unaided eye because those differences usually fall below the threshold of normal visual perception. These unit to unit differences, which may also be referred to as characteristics, usually exist in every part of the article including any attached printed or marked identifying labels or tags. Thus; since no two physical articles, products, etc., are truly identical, it should always be possible to detect many of such physical differences, characteristics, in each manufactured product, article, etc.; especially using mechanical or optical measuring tools.

The obvious goal of counterfeiters is to copy original product, article, etc. designs, and make counterfeit articles of sufficient “quality” to perceptively fool a purchaser/consumer. Today, some of the most sophisticated counterfeiters are making products, articles and the like, which are difficult, if not impossible to detect, with the naked eye, from the originals. This presents a significant problem to Product Brand companies seeking to enforce their Intellectual Property Rights.

Even if the Brand Company seizes and impounds “suspect product copies” in the market-place, it still must prove they are truly counterfeits in court to obtain relief through the legal system.

Over the last several decades, many new technologies and procedural concepts have been introduced to help manufacturers defend against counterfeiters. Given the continuing increase in global counterfeiting, it is fair to state that most of these techniques have had little or no lasting remedial effect.

Some anti-counterfeiting concepts involve embedding or adding product features, overtly or covertly, to the basic product design in order to help differentiate a bogus from the original. The most obvious problem with these techniques is that counterfeiters learn what they are, and then copy the anti-counterfeit feature itself, just like they copy the original product design. Most such anti-counterfeiting schemes appear to have had limited success

### SUMMARY OF THE INVENTION

Therefore, it is an object of the invention, to provide a new and novel anti-counterfeiting tool.

It is another object of the invention, to provide a new and novel anti-counterfeiting system.

It is still another object of this invention, to provide a new and novel anti-counterfeiting system wherein a sub-perception image of a selected portion of an article is combined with an added technology.

It is yet another object of this invention, to provide a new and novel anti-counterfeiting system wherein a sub-perception image of a selected portion of an article is combined with a serialized number.

It is yet still another object of this invention, to provide a new and novel anti-counterfeiting system wherein a sub-perception image of a selected portion of an article is combined with a unique indicia.

It is yet still another object of this invention, to provide a new and novel anti-counterfeiting system wherein a sub-perception image of a selected portion of an article is combined with a perceived unique indicia.

This invention utilizes the random unit to unit physical differences, characteristics, inherent in any manufacturing process, especially such processes which include selected key marking or printing elements of the articles design. The key elements selected are those which facilitate detection of the unit to unit differences generated, in an uncontrolled manner, by the manufacturing process. The visual appearance to the naked eye of the unit to unit differences of such key elements usually falls below the threshold of human perception, but enables their use for ant-counterfeiting purposes.

An “Anti-Counterfeit Detector”, for use in determining whether an article is, or is not, counterfeit, is generated by combining a selected key element with a unique identifier. The application of the Anti-Counterfeit Detector to a product, article, or the like, and the recording of a high resolution visual image of both the key element and it's article's unique identifier by electronic and/or other suitable means, provides a Counterfeiting Data Base for subsequent access by authorized personnel. A counterfeiter may see, copy and apply the unique identifier and with appropriate tools observe the many unit to unit differences in the article, but has no way of determining which of the many differences was utilized as the applied key element, because there are too many possibilities to select from, and a potential counterfeiter is left with a quandary.

Because of that quandary, the potential counterfeiter may decide to seek to target another Brand products or articles. Alternatively, the counterfeiter may take a chance and select a different portion of the article to utilize for the counterfeit article and thus the counterfeit may be detected

If a counterfeiter copies a product design and makes a “fake” product unit, even to the same level of quality and consistency as that of the brand manufacturer (including having it made in the same factory, by the same workers, using the same raw materials), and also copies a unique identifier from a genuine product unit, the Anti-Counterfeiting System methodology described herein will enable a brand owner, or other interested party, to detect the fake product from any of the brand's genuine products.

Even the most competent and diligent counterfeiter does not have the manufacturing control needed to replicate tiny physical features of a product which occur randomly, especially because they will not know which of the virtually infinite small areas of the product the brand company has selected to magnify, image and record. Even if such physical replication were possible, the cost of manufacture for the counterfeiter would be greatly in excess of the brand's manufacturing cost, thus eliminating the counterfeiter's financial incentive.

### BRIEF DESCRIPTION OF THE DRAWINGS

Some of the objects of the invention have been set out above. Other objects and advantages of the invention will appear as the description proceeds when taken in conjunction with the following drawings in which shoes from the Converse Company are used as a specific example of the general case (since the invention can be applied to all articles):

FIG. 1 is a normal, regular size photo of the Brand markings of each shoe for a pair of Converse shoes of the same style and size;

FIG. 2 is a highly magnified showing of one of the points, of the five pointed star, of the Brand marking of one of the shoes of FIG. 1;

FIG. 3 is a highly magnified showing of another one of the points, of the five pointed star of FIG. 2; but could be of one of the points of a 5 pointed star of a different Converse shoe.

FIG. 4 is a schematic sketch of an Anti-Counterfeit Detector; and

FIG. 5 is a schematic of a Converse Company sneaker production line incorporating the anti-counterfeiting system of the instant invention; and

FIG. 6 is a schematic showing use of the anti-counterfeiting system of the instant invention inspecting an article to determine if the article is genuine or counterfeit.

### DESCRIPTION OF THE INVENTIVE EMBODIMENT

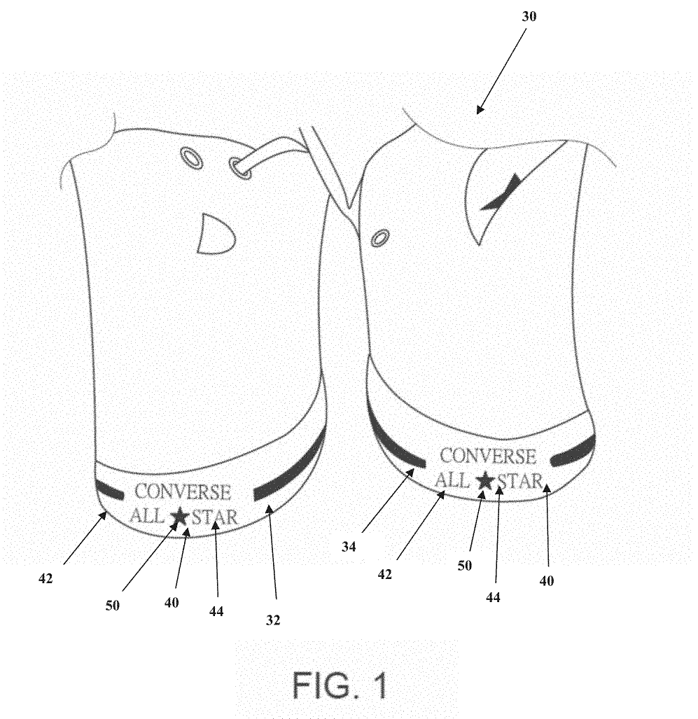

Using footwear products as an example, FIG. 1 shows a pair of shoes 30 of the same style and size. In these normal regular size photos, there is no discernable difference between the two units 32 and 34 of shoes 30. Each shoe 32, 34, of the pair of shoes 30, carries a Brand marker 40 consisting of the mark “ALL” 42 and the mark “STAR” 44 with a five pointed star 50 positioned between “ALL” and “STAR”.

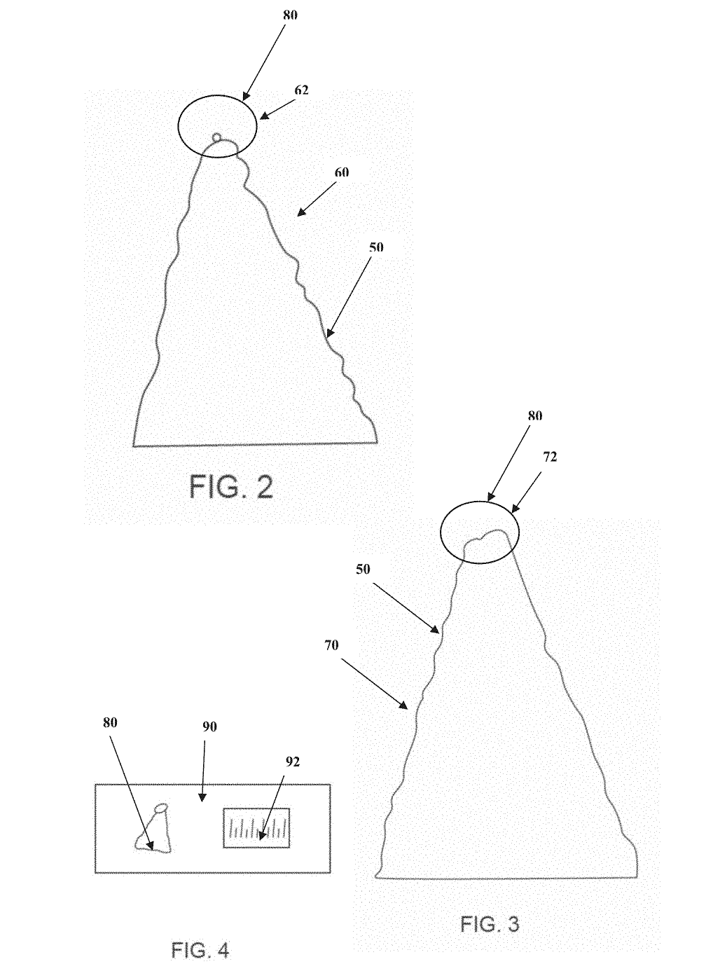

FIGS. 2 and 3, respectively, show at 60 (FIGS. 2) and 70 (FIG. 3) magnified images of different star points of a 5 pointed star 50. It should be noted that image 60 and image 70 are different, at respective circled areas 62 (for image 60) and 72 (for image 70) even though they are of a same small area located in the same place on each unit. These obvious differences are easily visible due to the selected magnification. The respective images 62 and 72 illustrate differences, characteristics, of the articles (shoes) and constitute key elements 80 of the instant invention.

FIG. 4 shows an anti-counterfeit detector 90 in the form of a tag, label, or the like, which is for application to an article, or a package for, or of, an article which has not previously been marked for counterfeit protection. Detector 90 may be made by printing, or other suitable process, but like the embodiments previously described, each detector 90 will be different from other detectors 90 under microscopic inspection and , will show deficiencies, characteristics suitable for purposes previously described. Thus tag, label 90 may store a sub-perceivable image 88 and a locator 92 visible to the naked eye for use as described for the previously described embodiment and, if required, an image of a selected key element 88 but which is not to be visible to the naked eye.

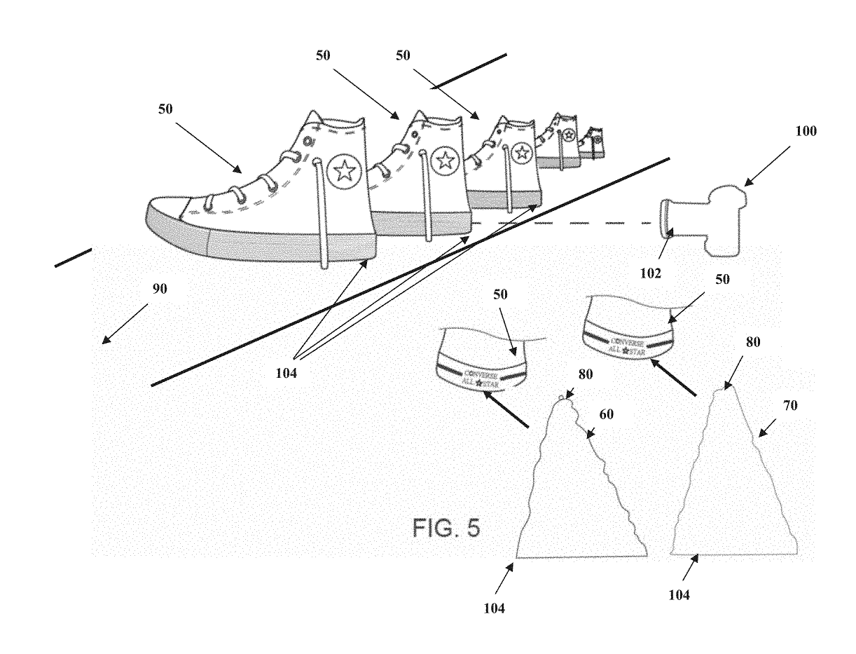

FIG. 5 shows an embodiment of an example of using the instant invention for the shoes 50 of FIG. 1. In this embodiment shoes 50 are selected for anti-counterfeit treatment (marking) as the shoes move along a production line 90. In this way the shoes are so marked during their usual movement while being manufactured. It should be understood that shoes 50 could just as well have been previously manufactured and stored and subsequently removed from storage to be so marked, or that line 90 me be that of an offshoot of shoe manufacture.

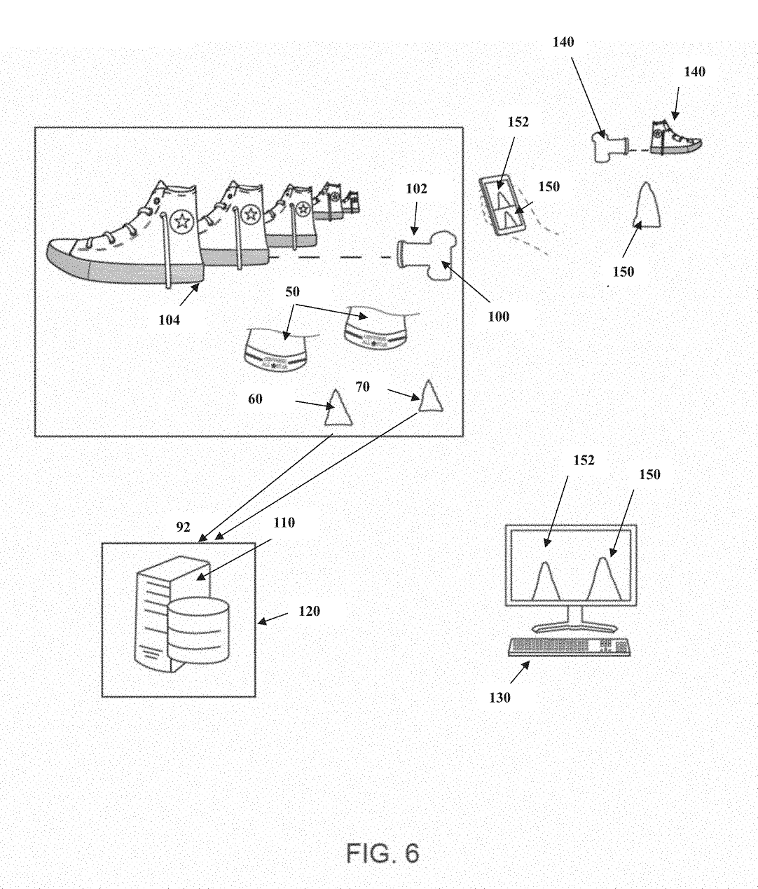

An imaging device, camera, or the like, 100, equipped with a magnification lens 102, is positioned to image a selected location 104 of each shoe 50 to obtain a sub-perception image such as images 80, FIGS. 5 and 6., The respective sub-perception images 80 are each assigned a unique locator 92, different for each such image. Each unique locator 92, along with the sub-perception image it had been assigned to, is entered into a data base 110 of a data storage facility 120 (FIG. 6)

Verification that an article may, or may not, be genuine may thereafter be accomplished by entering the unique locator 92 of the article into either a computer 130 (FIG. 6) or a smart mobile device 132, or by imaging the locator 92 by a camera 140 equipped for sub-perception imaging. The respective images 150, 152, otherwise sub-perceivable, will appear on either the mobile device 132 or the computer monitor 160 for comparison by an interested party. If the respective images 150, 152, now visible to the naked eye, are alike the article is genuine. I the respective images 150, 152 are different to the viewers naked eye, then the article is counterfeit.

What is claimed is:

1. Detecting counterfeit articles; comprising,
(a). visually examining an article, under a predetermined magnification, to select a characteristics of the article that is not visible to naked eye examination without magnification;
(b) assigning to said selected characteristic a locator that is visible to the naked eye;
(c) saving said locator and its selected characteristic in a database;
(d) utilizing said locator to access said database to verify that an article is not a counterfeit when said locator and said characteristic match the saved locator and characteristic.

2. The detecting of counterfeit articles of claim 1 wherein said visual examination reveals plural characteristics from which only one of said characteristics is selected and has a said locator assigned to it.

3. The detecting of counterfeit articles of claim 1 wherein said locator is applied directly onto the article.

4. The detecting of counterfeit articles of claim 1 wherein said locator is applied to a carrier which is associated with the article.

5. The detecting of counterfeit articles of claim 1 wherein said locator and its selected characteristic are applied to a carrier which is associated with the article.
